(19) United States
(12) Patent Application Publication
(10) Pub. No.: US 2026/0088046 A1
(43) Pub. Date: Mar. 26, 2026

(54) LOAD BEAM WITH VARYING THICKNESS FOR MAGNETIC STORAGE DEVICE

(71) Applicant: Western Digital Technologies, Inc., San Jose, CA (US)

(72) Inventors: Yoshinobu Noguchi, Yokohama-shi (JP); Hiroyasu Tsuchida, Fujisawa (JP); Takuma Muraki, Yamato-shi (JP); Tomoyuki Sasaki, Yokohama-shi (JP)

(21) Appl. No.: 18/895,162

(22) Filed: Sep. 24, 2024

(51) Int. Cl. G11B 5/48

(52) U.S. Cl. CPC G11B 5/4833; G11B 5/484; G11B 5/4853

(57) ABSTRACT

Examples of the present disclosure include a suspension assembly for a magnetic storage device. The suspension assembly includes a load beam and a flexure. The load beam includes a flexure side and a base-plate side opposite to the flexure side. The load beam also includes a recess formed in the flexure side. The flexure is attached to the flexure side of the load beam at least partially within the recess.

### FIELD

This disclosure relates generally to magnetic storage devices, and more particularly to load beams with varying thicknesses.

### BACKGROUND

Magnetic storage devices, such as hard disk drives (“HDDs”), are widely used to store digital data or electronic information for enterprise data processing systems, computer workstations, portable computing devices, digital audio players, digital video players, and the like. Generally, HDDs include read-write heads that help facilitate storage of data on magnetic disks. Each read-write head is supported on a suspension assembly. Some HDDs include a suspension assembly with a flexure.

### SUMMARY

A need exists for a magnetic storage device, and a method of manufacturing the same, which helps to maintain separation between a flexure of a suspension assembly of the magnetic storage device and a magnetic storage disk, while reducing spacing between the disks of the magnetic storage device. The subject matter of the present application has been developed in response to the present state of magnetic storage devices, and in particular, in response to problems and needs in the art, such as those discussed above, that have not yet been fully solved by currently available magnetic storage devices. Accordingly, the examples of the present disclosure overcome at least some of the shortcomings of the prior art.

The following is a non-exhaustive list of examples, which may or may not be claimed, of the subject matter, disclosed herein.

Disclosed herein is a suspension assembly for a magnetic storage device. The suspension assembly includes a load beam and a flexure. The load beam includes a flexure side, a base-plate side opposite to the flexure side, and a recess formed in the flexure side. The flexure is attached to the flexure side of the load beam at least partially within the recess. The preceding subject matter of this paragraph characterizes example 1 of the present disclosure.

The suspension assembly further includes a base plate attached to the base-plate side of the load beam. The load beam further includes a distal end portion, a proximal end portion, and a hinge between the distal end portion and the proximal end portion. The proximal end portion is attached to the base plate. The hinge is interposed between the distal end portion and the base plate, and the load beam is configured to flex about the hinge so that the distal end portion moves relative to the base plate. The preceding subject matter of this paragraph characterizes example 2 of the present disclosure, wherein example 2 also includes the subject matter according to example 1, above.

The recess is at least partially located on the proximal end portion of the load beam. The preceding subject matter of this paragraph characterizes example 3 of the present disclosure, wherein example 3 also includes the subject matter according to example 2, above.

A maximum width of the flexure is greater than a width of the recess. The preceding subject matter of this paragraph characterizes example 4 of the present disclosure, wherein example 4 also includes the subject matter according to any one of examples 2-3, above.

A portion of the recess on the proximal end portion is greater than any portion of the recess on the distal end portion. The preceding subject matter of this paragraph characterizes example 5 of the present disclosure, wherein example 5 also includes the subject matter according to any one of examples 2-4, above.

The suspension assembly further includes two actuators coupled to the base plate and configured to cause the load beam to move. The recess is located between two actuators. The preceding subject matter of this paragraph characterizes example 6 of the present disclosure, wherein example 6 also includes the subject matter according to any one of examples 2-5, above.

A bifurcating plane passing through a center of the suspension assembly bifurcates the recess into two equal halves. The preceding subject matter of this paragraph characterizes example 7 of the present disclosure, wherein example 7 also includes the subject matter according to any one of examples 1-6, above.

The recess is configured to receive the flexure such that a substrate of the flexure fills only a portion of the recess. The preceding subject matter of this paragraph characterizes example 8 of the present disclosure, wherein example 8 also includes the subject matter according to any one of examples 1-7, above.

The recess is configured to face a first flexure-side of the flexure when the recess receives the flexure. The load beam further comprises a non-recessed portion located immediately adjacent to the recess. A ratio of a distance between the base-plate side and a second flexure-side opposite to the first flexure-side, when the flexure is received by the recess, to a thickness of the non-recessed portion to is between and inclusive of 1.3 and 1.9. The preceding subject matter of this paragraph characterizes example 9 of the present disclosure, wherein example 9 also includes the subject matter according to any one of examples 1-8, above.

A maximum width of a portion of the flexure within the recess is less than a width of the recess. The preceding subject matter of this paragraph characterizes example 10 of the present disclosure, wherein example 10 also includes the subject matter according to any one of examples 1-9, above.

The load beam further includes a non-recessed portion located immediately adjacent to the recess and a ratio of a thickness of the non-recessed portion to a thickness of a portion of the load beam in which the recess is formed is not less than 1.7. The preceding subject matter of this paragraph characterizes example 11 of the present disclosure, wherein example 11 also includes the subject matter according to any one of examples 1-10, above.

The ratio is not greater than ten. The preceding subject matter of this paragraph characterizes example 12 of the present disclosure, wherein example 12 also includes the subject matter according to example 11, above.

A width of the recess, in a virtual plane substantially perpendicular to a length of the load beam, is less than a width of the load beam in the virtual plane. The preceding subject matter of this paragraph characterizes example 13 of the present disclosure, wherein example 13 also includes the subject matter according to any one of examples 1-12, above.

The flexure includes a plurality of layers. A depth of the recess is greater than or equal to a thickness of a substrate layer of the plurality of layers. The preceding subject matter of this paragraph characterizes example 14 of the present disclosure, wherein example 14 also includes the subject matter according to any one of examples 1-13, above.

The plurality of layers further comprises a dielectric layer attached to the substrate layer, the substrate layer is received by the recess, and the dielectric layer is not received by the recess. The preceding subject matter of this paragraph characterizes example 15 of the present disclosure, wherein example 15 also includes the subject matter according to example 14, above.

Further disclosed herein is a magnetic storage system that includes a quantity of disks and a carriage. The carriage includes a base plate and a magnetic storage system. The base plate includes a flexure side, a base-plate side opposite to the flexure side, a recess formed in the flexure side, a distal end portion, and a hinge. The hinge is interposed between the distal end portion and the base plate and is configured to flex so that the distal end portion moves relative to the base plate. The carriage also includes a flexure attached to the flexure side of the load beam at least partially within the recess. The preceding subject matter of this paragraph characterizes example 16 of the present disclosure.

The hinge biases towards a surface of at least one disk of the quantity of disks to allow a head of the distal end portion to read data from and/or write data to the at least one disk. The preceding subject matter of this paragraph characterizes example 17 of the present disclosure, wherein example 17 also includes the subject matter according to example 16, above.

The load beam includes a first load beam. The base plate comprises a first base plate. The recess comprises a first recess. The carriage further includes a second load beam, a second base plate, and a second recess formed in the second load beam. The second recess faces away from the first recess. The preceding subject matter of this paragraph characterizes example 18 of the present disclosure, wherein example 18 also includes the subject matter according to any one of examples 16-17, above.

Additionally disclosed herein is a method of manufacturing a suspension assembly of a magnetic storage device. The method includes attaching a flexure to a means for at least partially insetting the flexure into a load beam on a flexure side of the load beam. The flexure side is opposite to a base-plate side of the load beam. The preceding subject matter of this paragraph characterizes example 19 of the present disclosure.

The means for at least partially insetting the flexure into the load beam includes a recess in the flexure side of the load beam. The method further includes forming the recess into the flexure side by removing material from the load beam to form the recess such that a ratio of a thickness, of a non-recessed portion of the load beam immediately adjacent to the recess, to a depth of the recess is between and inclusive of 1 and 2.3. The preceding subject matter of this paragraph characterizes example 20 of the present disclosure, wherein example 20 also includes the subject matter according to example 19, above.

The described features, structures, advantages, and/or characteristics of the subject matter of the present disclosure may be combined in any suitable manner in one or more examples and/or implementations. In the following description, numerous specific details are provided to impart a thorough understanding of examples of the subject matter of the present disclosure. One skilled in the relevant art will recognize that the subject matter of the present disclosure may be practiced without one or more of the specific features, details, components, materials, and/or methods of a particular example or implementation. In other instances, additional features and advantages may be recognized in certain examples and/or implementations that may not be present in all examples or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims or may be learned by the practice of the subject matter as set forth hereinafter.

### BRIEF DESCRIPTION OF THE DRAWINGS

In order that the advantages of the disclosure will be readily understood, a more particular description of the disclosure briefly described above will be rendered by reference to specific examples that are illustrated in the appended drawings. Understanding that these drawings depict only typical examples of the disclosure and are not therefore to be considered to be limiting of its scope, the subject matter of the present application will be described and explained with additional specificity and detail through the use of the accompanying drawings, in which:

FIG. 1 is a schematic perspective view of a magnetic storage device, according to one or more examples of the present disclosure;

FIG. 2 is a side elevation view of a head stack assembly, according to one or more examples of the present disclosure;

FIG. 3A is an underside view of a suspension assembly of a magnetic storage device, and a detailed view of a recess of a load beam of the suspension assembly, according to one or more examples of the present disclosure;

FIG. 3B is a cross-sectional side elevation view of a suspension assembly of a magnetic storage device, taken along the plane A-A of FIG. 3A, according to one or more examples of the present disclosure; and

FIG. 4 is a flow chart of a method of manufacturing a suspension assembly of a magnetic storage device, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure. However, absent an express correlation to indicate otherwise, an implementation may be associated with one or more examples.

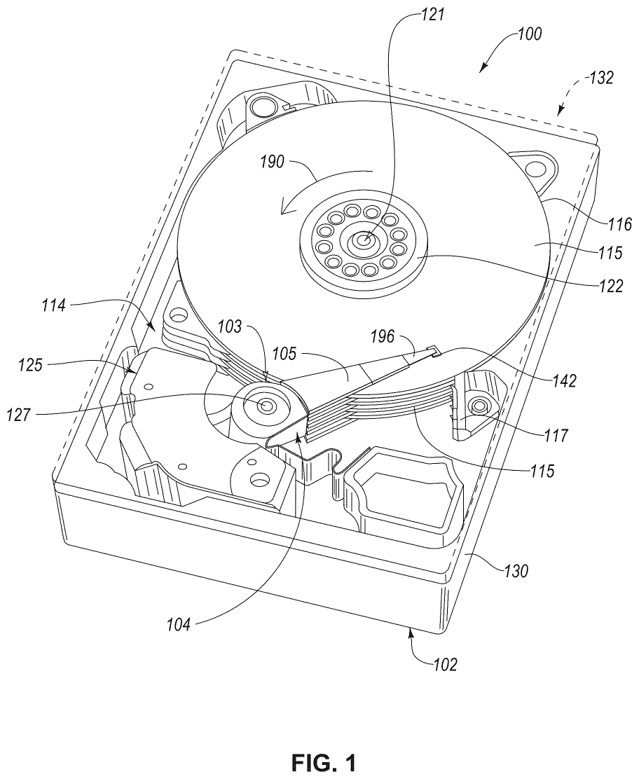

Referring to FIG. 1, a magnetic storage device 100, according to one example, is depicted as a hard disk drive (HDD). However, in other examples, the magnetic storage device 100 can be any of various magnetic storage devices without departing from the essence of the subject matter of the present disclosure. The magnetic storage device 100 includes a housing 102 that seals or encloses an interior cavity 114 defined within the housing. The housing 102 includes a base 130 and a cover 132 (shown in dashed lines so as not to obscure internal features of the magnetic storage device 100 within the interior cavity 114 of the housing 102). The cover 132 is coupled to the base 130 to enclose the interior cavity 114 from the environment exterior to the housing 102. In some implementations, a seal or gasket is positioned between the base 130 and the cover 132 to promote a seal between the base 130 and the cover 132. In some examples, the base 130 is made of a metallic material, such as stainless steel.

The magnetic storage device 100 includes various features located within the interior cavity 114 of the housing 102. In some examples, the magnetic storage device 100 includes a carriage 103, disks 115, a spindle motor 121, and a voice coil motor (VCM) 125 within the interior cavity 114.

The spindle motor 121 is coupled to the base 130. Generally, the spindle motor 121 includes a stationary portion non-movably fixed relative to the base 130 and a spindle that is rotatable relative to the stationary portion and the base 130. Accordingly, the spindle of the spindle motor 121 can be considered to be part of or integral with the spindle motor. Generally, the spindle motor 121 is operable to rotate the spindle relative to the base 130. The disks 115, or platters, are co-rotatably fixed to the spindle of the spindle motor 121 via respective hubs 122, which are co-rotatably secured to respective disks 115 and the spindle. As the spindle of the spindle motor 121 rotates, the disks 115 correspondingly rotate. In this manner, the spindle of the spindle motor 121 defines a rotational axis of each disk 115. The spindle motor 121 can be operatively controlled to rotate the disks 115, in a rotational direction 190, a controlled amount at a controlled rate. Although the magnetic storage device 100 is shown to have one spindle motor 121 and one VCM 125, in other examples, the magnetic storage device 100 can have any number of spindle motors 121 and VCMs 125.

Each one of the disks 115 may be any of various types of magnetic recording media. Generally, in one example, each disk 115 includes a substrate and a magnetic material applied directly or indirectly onto the substrate. For example, the magnetic material of the disks 115 may be conventional granular magnetic recording disks or wafers that have magnetic layer bits with multiple magnetic grains on each bit. In granular magnetic media, all of the bits are co-planar and the read/write surface 116 of the disk is substantially smooth and continuous. In one example, each bit has a magnetic dipole moment that can either have an in-plane (longitudinal) orientation or an out-of-plane (perpendicular) orientation.

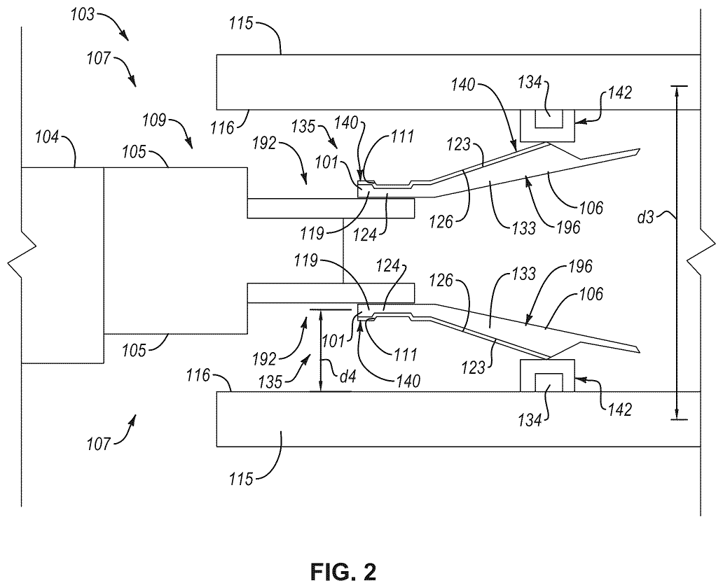

Referring to FIGS. 1 and 2, as the disks 115 rotate in a read-write mode, the VCM 125 electromagnetically engages voice coils of the carriage arms 105 to rotate the carriage arms 105, and the head-gimbal assemblies 109, which are coupled to the carriage arms 105, relative to the disks 115 in a rotational direction along a plane parallel to read-write surfaces 116 of the disks 115. The carriage arms 105 can be rotated to position the read-write head 134 of the head-gimbal assemblies 109 over a specified radial area of the read-write surface 116 of a corresponding disk 115 for read and/or write operations. The VCM 125 is fixed to the base 130 in engagement with the voice coils of the carriage arms 105, which are rotatably coupled to the base 130 via a spindle 127 extending through the carriage 103. Generally, the spindle 127 defines a rotational axis about which the carriage arms 105 rotate when actuated by the VCM 125.

The carriage arms 105 are non-movably fixed to (e.g., integrally formed as a one-piece unitary monolithic body with) and extend away from a base of the carriage 103 in a spaced-apart manner relative to each other. In some implementations, the carriage arms 105 are spaced an equi-distance apart from each other and extend parallel relative to each other. A respective one of the disks 115 is positioned between adjacent carriage arms 105. In an idle mode (e.g., when read-write operations are not being performed), the VCM 125 is actuated to rotate the carriage arms 105, in a radially outward direction relative to the disks 115, such that the head-gimbal assemblies 109 are parked or unloaded onto a ramp support 117 secured to the base 130.

Referring to FIG. 2, the head stack assembly 107 includes a carriage 103, which includes a plurality of carriage arms 105 and at least one head-gimbal assembly 109 (e.g., suspension), coupled to the distal tip of each carriage arm 105 of the plurality of carriage arms 105. Each head-gimbal assembly 109 includes a suspension assembly 135 and a slider 142. The slider 142 includes at least one read/write head 134 coupled to (e.g., embedded in) a housing of the slider 142. Although the magnetic storage device 100 in FIG. 1 is shown to have five carriage arms 105 and four disks 115, and FIG. 2 only shows one carriage arm 105 and two disks 115, in other examples, the magnetic storage device 100 can have fewer or more than five carriage arms 105 or fewer or more than four disks 115. In one example, each side of each carriage arm 105 facing a disk 115 has a head-gimbal assembly 109 (e.g., each one of bottom and top carriage arms 105 can have one head-gimbal assembly 109 and, referring to FIG. 2, each one of middle carriage arms 105, between the bottom and top carriage arms 105, can have two head-gimbal assemblies 109).

The read-write head 134 of the slider 142 includes at least one read transducer and at least one write transducer. The read transducer is configured to detect magnetic properties (e.g., magnetic bit patterns) of a disk 115 and convert the magnetic properties into an electrical signal. In contrast, the write transducer changes the magnetic properties of a disk 115 responsive to an electrical signal. For each head-gimbal assembly 109, the electrical signals are transmitted from and to the read-write head via electrical traces or lines formed in or coupled to the slider 142 and the flexure 140. The electrical traces of the slider 142 and the flexure 140 are electrically interconnected to facilitate transmission of electrical signals between the read-write head and a flex connector 104 of the magnetic storage device 100, which is in communication with a control module of the magnetic storage device 100 (see, e.g., FIG. 1). The control module is configured to process the electrical signals and facilitate communication of the electrical signals between the magnetic storage device 100 and one or more external computing devices. Generally, the control module includes software, firmware, and/or hardware used to control operation of the various components of the magnetic storage device 100. The control module may include a printed circuit board on or in which the hardware is mounted. Solder weldments are utilized to electrically connect corresponding electrical contact pads (and corresponding electrical traces) of the slider 142 and the flexure 140.

FIG. 2 is a side elevation view of one example of the head stack assembly 107. The head stack assembly 107 of FIG. 2 includes a carriage arm 105 and two head-gimbal assemblies 109 coupled to that carriage arm 105. A portion of the carriage arm 105 is disposed between two disks 115. Although FIG. 2 only shows one carriage arm 105, the head stack assembly 107 includes multiple carriage arms 105 in some examples. As mentioned above, each head-gimbal assembly 109 includes the suspension assembly 135 and the slider 142, which has the read/write head 134 configured to read data from and/or write data to one of the disks 115.

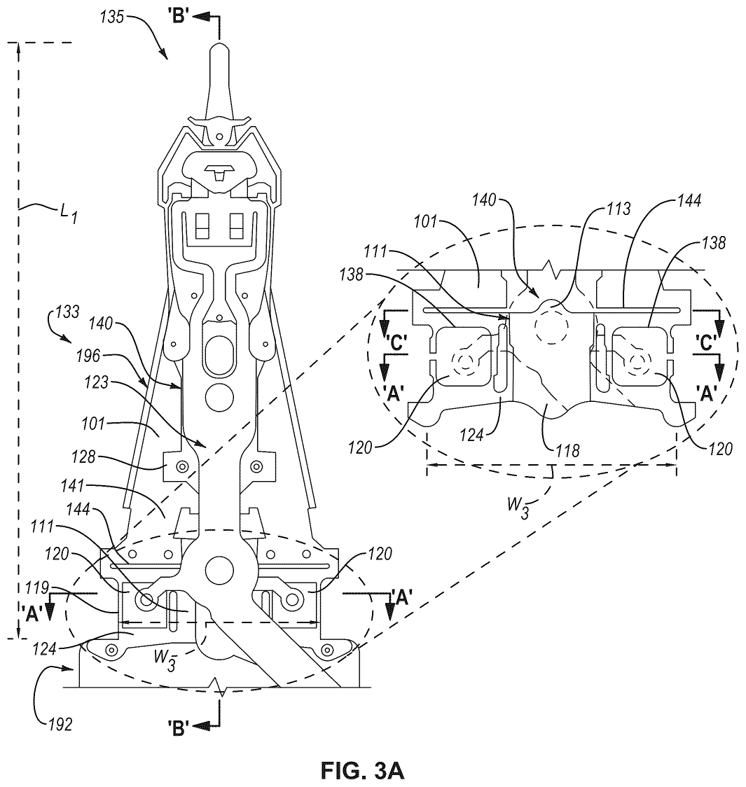

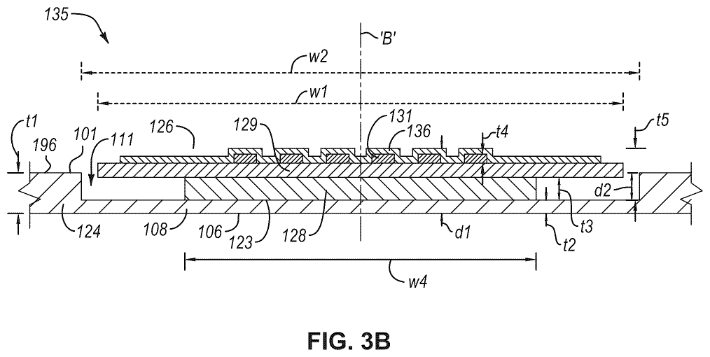

In some examples of the present disclosure, the suspension assembly 135 includes a base plate 192 and a load beam 196, side views of which are illustrated in FIG. 2 and undersides of which are illustrated in FIG. 3A. The base plate 192 spans between and couples together a distal end of the carriage arm 105 and a proximal end of the load beam 196. The load beam 196 bends with respect to the base plate 192 of the suspension assembly 135 via a hinge 141 of the load beam 196. The hinge 141 biases the load beam 196 towards a read/write surface 116 of a corresponding one of the disks 115 to enable the read/write head 134 of the suspension assembly 135 to read data from and/or write data to the corresponding one of the disks 115. In some examples, the read/write head 134 floats above the read/write surface 116 as the disk 115 rotates relative to the read/write head 134.

In some examples, the load beam 196 is made of a resiliently flexible material, such as a metallic material. When bent, the hinge 141 works as a spring to generate force (referred to herein as “gram load”) to urge the head 134 of the load beam 196 towards the read/write surface 116 into a position such that the flying height between read/write surface 116 and the read/write head 134 is minimal. This is accomplished, for example, through forced air or another gas (e.g., helium). A gap between the read/write head 134 and the disk 115 may be referred to herein as a “flying height” or “floating height.” It is often preferrable to minimize this gap and/or to stabilize it to maximize signal quality of data transmitted between the disk 115 and the read/write head 134. In some examples, the flying height is approximately equal to or less than five nanometers (“nm”). However, examples of the present disclosure are not so limited.

The suspension assembly 135 also includes a flexure 140 that extends along the undersides of the base plate 192 and the load beam 196. The flexure 140 includes a portion that extends over (e.g., traverses) the hinge 141. As used herein, the term “underside” refers to any side of the base plate 192 and/or the load beam 196 facing a read/write surface 116 which the corresponding read/write head 134 is urged to move toward.

Referring again to FIG. 2, decreasing a distance d3 between disks 115 can enable the magnetic storage device 100 to accommodate a greater quantity of disks 115 (see, e.g., FIG. 2). If possible, reducing the distance d3 while maintaining a suspension-to-disk height d4 between the flexure 140 and the disk 115 can help to maintain performance and improve design and component flexibility while making room for more disks 115 in the magnetic storage device 100. As such, embodiments of the present disclosure include a load beam 196 with a recess 111 configured to receive a portion of a flexure 140 to help maintain the suspension-to-disk space d4 while decreasing the distance d3 between disks 115.

FIG. 3A is an underside view of the suspension assembly 135 of the magnetic storage device 100, according to one or more examples of the present disclosure. Referring to FIGS. 2 and 3A-3B, the load beam 196 includes a flexure side 101 and a base-plate side 106 opposite to the flexure side 101. The suspension assembly 135 also includes the flexure 140, which is attached to the flexure side 101 of the load beam 196 at least partially within the recess 111.

The base plate 192 of the suspension assembly 135 is attached to the base-plate side 106 of the load beam 196. The load beam 196 includes a distal end portion 133 and a proximal end portion 119. The proximal end portion 119 is attached to the base plate 192. In some examples, the distal end portion 133 is not attached to the base plate 192. The hinge 141 is interposed between the distal end portion 133 and the base plate 192, such that the proximal end portion 119 is opposite to the distal end portion 133 with respect to the hinge 141. The load beam 196 is configured to flex about the hinge 141 so that the distal end portion 133 can move relative to the base plate 192. For example, referring to FIGS. 2 and 3A, the load beam 196 is configured to flex about the hinge 141 such that the distal end portion 133 is urged towards the read/write surface 116 of a disk 115.

FIG. 3B is a cross-sectional side elevation view of the suspension assembly 135 along the virtual plane ‘A’ shown in FIG. 3A, according to one or more examples of the present disclosure. Referring to FIGS. 3A and 3B, the recess 111 of the load beam 196 is formed in the flexure side 101 of the load beam 196. The recess 111 can receive at least a portion of the flexure 140. Referring to FIG. 2, the recess 111, by receiving the flexure 140 at least partially therein, enables as reduction of the distance d3 between the disks 115, while maintaining a suspension-to-disk space d4 between the flexure 140 and the disk 115.

As shown in FIG. 3B, the recess 111 defines a recessed portion 108 of the load beam 196. The recess 111 is at least partially located on the proximal end portion 119 of the load beam 196. In some examples, the recess 111 is mostly located on the proximal end portion 119 of the load beam 196. In some examples, an area of a portion of the recess 111 on the proximal end portion 119 is greater than any area of the portion of the recess 111 on the distal end portion 133. In other examples, the recess 111 is located entirely on the proximal end portion 119.

Referring to FIG. 3A, in some examples, the recess 111 at least partially overlaps a gap plane ‘C’ that includes the gap 144 and is substantially perpendicular to a bifurcating plane ‘B.’ In some examples, a first portion 113 of the recess 111 is located opposite to a second portion 118, with the gap plane ‘C’ effectively dividing the first portion 113 from the second portion 118. The bifurcating plane ‘B’ bifurcates the load beam 196 into two equal halves in a direction substantially parallel to the length L1 of the load beam 196. The gap plane ‘C’ is also substantially perpendicular to the length L1 of the load beam 196. The first portion 113 and the second portion 118 form a continuous recess 111. In some examples, both the first portion 113 and the second portion 118 are located on the proximal end portion 119 of the load beam 196. In such examples, the first portion 113 does not flex with respect to the second portion 118, as the distal end portion 133 flexes with respect to the proximal end portion 119 about the hinge 141. As shown in FIG. 3A, in some examples, an area of the first portion 113 is less than an area of the second portion 118.

Referring back to FIG. 3B, in some examples, the recess 111 is substantially centered with respect to the load beam 196. For example, as shown in FIG. 3B, the bifurcating plane ‘B’ passing through a center of the suspension assembly 135 bifurcates the recess 111 into two equal halves. In various examples, the plane ‘B’ is substantially perpendicular to the hinge 141 and/or substantially parallel to a length L1 of the load beam 196.

In some implementations, the head-gimbal assembly 109 includes actuators 120 that are selectively operable to move (e.g., pivot) the read-write head 134 relative to the base plate 192 at a location associated with where a portion of the flexure 140 intersects the hinge 141. Referring to FIG. 3A, the suspension assembly 135 includes at least two actuators 120. The actuators 120 can be, for example, piezoelectric (“PZT”) actuators. The actuators 120 are attached to the load beam 196 and the base plate 192 and are configured to cause the load beam 196 to move relative to the base plate 192. For example, the actuators 120 are configured to cause the distal end portion 133 of the load beam 196 to pivot, relative to the base plate 192, about an axis (extending into the page in FIG. 3A), thus rotating read-write head 134 to the left or right (relative to the page in FIG. 3A). As shown in FIG. 3A, the actuators 120 are electrically connected to the flexure 140.

Referring to FIGS. 3A-3B, the recess 111 is located between two actuators 120 when the load beam 196 is attached to the base plate 192. For example, the recess 111 is located on the load beam 196 between two actuator openings 138 in the proximal end portion 119 of the load beam 196. The actuator openings 138 are configured to receive actuators 120 attached to the base plate 192 when the load beam 196 is attached to the base plate 192. In some examples, the recess 111 is located entirely between the two actuators 120, meaning that the recess 111 does not overlap with either of the actuators 120 in any plane parallel to the plane ‘B.’

In some examples, the flexure 140 is a muti-layer flexure. As used herein, the term “layers” may be used to describe multiple consecutive or non-consecutive layers. Referring to FIG. 3B, layers of the flexure 140 include, for example, a substrate layer 128, a first dielectric layer 129, a third layer 131, and a second dielectric layer 136 arranged in a stacked formation. The first dielectric layer 129 can be interposed between the substrate layer 128 and the third layer 131 and/or the second dielectric layer 136.

In some examples, the substrate layer 128 is formed directly onto the load beam 196. Similarly to the load beam 196, the substrate layer 128 is often made of stainless steel or other similar materials and has a thickness that is greater than other layers of the multi-layer flexure 140. In some examples, the substrate layer 128 is made of a metallic material. According to some examples, the substrate layer 128 has a thickness (t3 as illustrated in FIG. 3B) of approximately 20 micrometers (“μm”). The substrate layer 128 can have a thickness t3 between, and inclusive of, 15 μm and 25 μm, such as approximately 18 μm. In some examples, the substrate layer 128 is attached to the load beam 196 to attach the overall flexure 140 to the load beam. In other words, the substrate layer 128 makes contact with and is located directly adjacent to the load beam 196.

Referring to FIG. 3B, a portion of the flexure 140 received by the recess 111 includes at least the substrate layer 128 of the flexure 140. In some examples, the substrate layer 128 is the only layer of the flexure 140 within the recess 111. The portion of the flexure 140 (e.g., the substrate layer 128) received by the recess 111, in some examples, does not completely fill the recess 111, such that gaps are defined within the recess 111 adjacent to the flexure 140. According to certain examples, the substrate layer 128 has a width w4 that is less than a maximum width w1 of the flexure 140. Other layers of the flexure 140 (e.g., first dielectric layer 129) can be wider than the substrate layer 128. In some examples, the recess 111 has a width w2 that is at least as wide or wider than the width w4 of the substrate layer 128 to allow the recess 111 to receive the substrate layer 128. The recess width w2 can also be greater than the maximum width w1 of the flexure 140 in some examples, but less than the maximum width w1 in other examples.

As illustrated in FIG. 3B, the substrate layer 128 can be completely within the recess 111 along the virtual plane ‘A.’ In some examples, the substrate layer thickness t3 is less than or equal to the depth d2 of the recess 111. The depth d2 of the recess 111 is a depth with respect to the flexure side 101 at the non-recessed portion 124. The substrate layer 128 is attached to the load beam 196 on the flexure side 101 and on an internal or base surface of the recess 111, such that the substrate layer 128 is received within the recess 111. Referring to FIG. 3B, in various examples, the substrate layer 128 is substantially centered with respect to the recess 111. The plane ‘B’ bifurcates both the recess 111 and the substrate layer 128 into equal halves in some examples.

The recess 111 faces a first flexure-side 123 of the flexure 140 when the recess 111 receives the flexure 140. The first flexure-side 123 includes a side of the substrate layer 128 opposite to the side of the substrate layer 128 onto which the first dielectric layer 129 is formed. In plane ‘A’, shown in FIG. 3B, the substrate layer 128 of the flexure 140 is the only layer of the flexure 140 that is directly attached to the load beam 196.

The flexure 140 includes a second flexure-side 126 opposite to the first flexure-side 123. The second flexure-side 126 includes sides of one or more layers of the flexure 140, other than the substrate layer 128. The second flexure-side 126 includes, for example, a second dielectric layer 136 of the flexure 140. In some examples, when the recess 111 receives the flexure 140, a distance d1 between the base-plate side 106 of the load beam 196 and the second flexure-side 126, which includes both a thickness t2 of the recessed portion 108 and a total flexure thickness t5 of the flexure 140, is between, and inclusive of, 40 to 60 μm. In one example, the distance d1 is approximately 48 μm.

In some examples, a thickness t1 of a non-recessed portion 124 of the load beam 196 immediately adjacent to the recess 111 is less than the distance d1, even when the flexure 140 is received by the recess 111. A ratio of the distance d1 to the thickness t1 of the non-recessed portion 124, when the flexure 140 is received by the recess 111, is between and inclusive of 1.3 and 1.9. In some examples, the thickness t2 of the recessed portion 108 is less than the thickness t1 of the non-recessed portion 124, but the thickness t2 of the recessed portion 108 is non-zero throughout, such that the load beam 196 is not completely recessed. A ratio of the thickness t1 of the non-recessed portion 124 to the thickness t2 of the recessed portion 108 is not less than 1.7. For instance, the thickness t1 of the non-recessed portion 124 is approximately 30 μm, and the thickness t2 of the recessed portion 108 is approximately 10 μm. The ratio of the thickness t1 to the thickness t2 can be between, and inclusive of, 1.7 and 10.

The recessed portion 108 of the load beam 196 defines only a portion of the load beam 196 (e.g., at least one of a maximum width of the recess 111 is less than a maximum width of the load beam 196 and/or a maximum length of the recess 111 is less than a maximum length L1 of the load beam 196). Referring to FIG. 3A, the recessed portion 108 is also less than an entirety of the proximal end portion 119 of the load beam 196. The recessed portion 108 does not extend along an entire length of the load beam 196. Limiting the area or size of the recessed portion 108 helps to maintain stiffness in the load beam 196. A width w2 of the recess 111, in plane ‘A’ substantially perpendicular to a length L1 of the load beam 196, is less than a total width w3 of the load beam 196 in the same plane ‘A.’

In some examples, a ratio of a load beam width (e.g., load beam width w3) to the recess width w2 in the same virtual plane perpendicular to the load beam length L1 (e.g., virtual plane ‘A’) is more than 1.2. For example, the ratio of the load beam width w3 to the recess width w2 in the plane ‘A’ is between and inclusive of 1.2 and 10. In some examples, the recessed portion 108 occupies an entirety of the proximal end portion 119 of the load beam 196 located between the two actuators. In other examples, the recessed portion 108 occupies less than an entirety of the proximal end portion 119 between the two actuators 120, such that at least some portions of the proximal end portion 119 between the two actuators 120 are not recessed.

Although not shown in FIG. 3B, the load beam 196 is attached to the base plate 192 at a base-plate side 106 of the load beam 196. For example, the proximal end portion 119 includes a portion of the base-plate side 106 and is attached to the base plate 192 at the base-plate side 106. The non-recessed portion 124 and the recessed portion 108 are flush along the base-plate side 106. The recessed portion 108 is attached to the base plate 192 at the base-plate side 106. Maintaining a non-zero thickness t2 of the load beam 196 in the recessed portion 108 helps to facilitate attachment of the load beam 196 to the base plate 192 at the recessed portion 108.

A first dielectric layer 129 of the flexure 140 is formed (e.g., applied) onto the substrate layer 128. In some examples, the first dielectric layer 129 is made of a dielectric and/or photosensitive material, such as a liquid polyimide. As illustrated in FIG. 3B, the first dielectric layer 129 forms a barrier between the substrate layer 128 and traces of the third layer 131 to help maintain signal quality. The thickness of the first dielectric layer 129 is positively correlated with signal quality. In various examples, the first dielectric layer 129 is made of a polyimide material, such as a polyimide film, polyimide resin, and/or any combination thereof.

Referring to FIG. 3B, in some examples, although the first dielectric layer 129 is not directly attached to the load beam 196 as is the substrate layer 128, in some examples, the recess 111 receives at least a portion of the first dielectric layer 129. In other examples, the first dielectric layer 129 is completely received by the recess 111. In yet another example, the thickness t3 of the substrate layer 128 is greater than the depth d2 of the recess 111, and the first dielectric layer 129 is not received within the recess 111.

As illustrated in FIG. 3B, in some examples, the flexure 140 includes an additional, third layer 131. The third layer 131 can be made of copper. In some examples, the copper of the third layer 131 is of a high purity, making it less stiff and more flexible. For example, the third layer 131 includes copper with a purity of over ninety-nine percent, or similar to the purity of electronic-grade copper foil. In some examples, the third layer 131 is portions of one or more signal traces for the flexure 140. In some examples, the flexure 140 includes a signal trace (sometimes referred to as a “circuit trace”) to conduct signals from the read/write head 134 to other components of the device 100. Although this trace is often made of copper and/or copper foil, examples of the present disclosure are not so limited. For example, in some examples, a trace is made of aluminum, gold, or any combination thereof. The third layer 131 is disposed between the first dielectric layer 129 and the second dielectric layer 136.

In some examples, the third layer 131 that has a thickness t4 (FIG. 3B) of approximately six micrometers (“μm”). As illustrated in FIG. 3B, the first dielectric layer 129 is interposed between the substrate layer 128 and the third layer 131. In some examples, the thickness t4 of the third layer 131 is less than the thickness t3 of the substrate layer 128. In other examples, each of the thicknesses t3 and t4 are approximately equal.

Referring to FIG. 2, in some examples, the magnetic storage device 100 includes a head stack assembly 107 having a plurality of carriage arms 105. In some examples, two head-gimbal assemblies 109 are coupled to the distal tip of each carriage arm 105, each of which includes a suspension assembly 135 and a slider 142. In such examples, each of the suspension assemblies 135 includes a load beam 196. The load beams 196 of the two head-gimbal assemblies 109 are arranged such that the flexure sides 101 of each load beam 196 face in opposite directions. A recess 111 is formed in the flexure side 101 of each of the two load beams 196 coupled to a given carriage arm 105. Accordingly, the two recesses 111 of the two load beams 196 face away from each other.

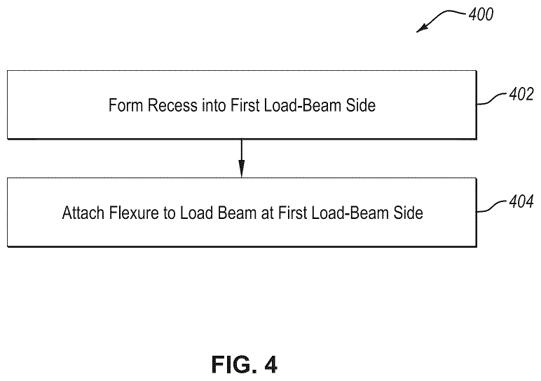

FIG. 4 is a flow chart of a method 400 of manufacturing a suspension assembly 135 of a magnetic storage device 100, according to one or more examples of the present disclosure. Specifically, the method 400 includes manufacturing a load beam 196 of the suspension assembly 135 of the magnetic storage device 100. Those of skill in the art will appreciate that any combination of steps illustrated in FIG. 4, and/or described herein, may be employed.

The method 400 includes a step 404 of attaching a flexure 140 to means for at least partially insetting the flexure 140 into a load beam 196 on a flexure side 101 of the load beam 196. In some examples, the means for at least partially insetting the flexure 140 into the load beam 196 includes a recess 111 in the flexure side 101, and attaching 404 the flexure 140 includes attaching the flexure 140 such that the flexure 140 is attached at least partially within a recess 111 formed into the flexure side 101 and such that the flexure 140 is at least partially inset into the load beam 196. The flexure side 101 can be opposite to a base-plate side 106 of the load beam 196. The base-plate side 106 is a side of the load beam 196 at which the load beam 196 is attached to the base plate 192.

In some examples, the method 400 additionally includes an additional step of forming 402 the recess 111 into the flexure side 101 prior to attaching the flexure 140 to the load beam 196. In some examples, the method 400 includes forming the recess 111 by removing material from the load beam 196. Removing material from the load beam 196 includes partially etching the load beam, such as via reactive ion etching, chemical etching, and/or some combination thereof. Removing the material from the load beam 196 can also be accomplished using other methods, including, but not limited to, laser ablation, mechanical grinding and/or cutting, ion milling, and/or any combination thereof. In other examples, the method 400 includes forming the recess 111 by forming the load beam 196 with the recess 111 in the flexure side 101 (e.g., by forming the load beam 196 in a mold).

In some examples, the method 400 includes forming the recess 111 into the flexure side 101 such that a ratio of a thickness t1 of a non-recessed portion 124 of the load beam 196 immediately adjacent to the recess 111 to a depth d2 of the recess 111 is between and inclusive of 1 and 2.3.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over.

Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A suspension assembly for a magnetic storage device, the suspension assembly comprising:
a load beam, comprising:
a flexure side;
a base-plate side opposite to the flexure side; and
a recess formed in the flexure side; and
a flexure attached to the flexure side of the load beam at least partially within the recess.

2. The suspension assembly of claim 1, further comprising a base plate attached to the base-plate side of the load beam, wherein:
the load beam further comprises a distal end portion, a proximal end portion, and a hinge between the distal end portion and the proximal end portion;
the proximal end portion is attached to the base plate;
the hinge is interposed between the distal end portion and the base plate; and
the load beam is configured to flex about the hinge so that the distal end portion moves relative to the base plate.

3. The suspension assembly of claim 2, wherein the recess is at least partially located on the proximal end portion of the load beam.

4. The suspension assembly of claim 2, wherein a maximum width of the flexure is greater than a width of the recess.

5. The suspension assembly of claim 2, wherein a portion of the recess on the proximal end portion is greater than any portion of the recess on the distal end portion.

6. The suspension assembly of claim 2, further comprising two actuators coupled to the base plate and configured to cause the load beam to move, wherein the recess is located between the two actuators.

7. The suspension assembly of claim 1, wherein a bifurcating plane passing through a center of the suspension assembly bifurcates the recess into two equal halves.

8. The suspension assembly of claim 1, wherein the recess is configured to receive the flexure such that a substrate of the flexure fills only a portion of the recess.

9. The suspension assembly of claim 1, wherein:
the recess is configured to face a first flexure-side of the flexure when the recess receives the flexure;
the load beam further comprises a non-recessed portion located immediately adjacent to the recess; and
a ratio of a distance between the base-plate side and a second flexure-side opposite to the first flexure-side, when the flexure is received by the recess, to a thickness of the non-recessed portion to is between and inclusive of 1.3 and 1.9.

10. The suspension assembly of claim 1, wherein a maximum width of a portion of the flexure within the recess is less than a width of the recess.

11. The suspension assembly of claim 1, wherein:
the load beam further comprises a non-recessed portion located immediately adjacent to the recess; and
a ratio of a thickness of the non-recessed portion to a thickness of a portion of the load beam in which the recess is formed is not less than 1.7.

12. The suspension assembly of claim 11, wherein the ratio is not greater than ten.

13. The suspension assembly of claim 1, wherein a width of the recess, in a virtual plane substantially perpendicular to a length of the load beam, is less than a width of the load beam in the virtual plane.

14. The suspension assembly of claim 1, wherein:
the flexure comprises a plurality of layers; and
a depth of the recess is greater than or equal to a thickness of a substrate layer of the plurality of layers.

15. The suspension assembly of claim 14, wherein:
the plurality of layers further comprises a dielectric layer attached to the substrate layer;
the substrate layer is received by the recess; and
the dielectric layer is not received by the recess.

16. A magnetic storage system, comprising:
a quantity of disks; and
a carriage comprising:
a base plate;
a load beam, attached to the base plate and comprising:
a flexure side;
a base-plate side opposite to the flexure side;
a recess formed in the flexure side;
a distal end portion; and
a hinge, wherein the hinge is interposed between the distal end portion and the base plate and is configured to flex so that the distal end portion moves relative to the base plate; and
a flexure attached to the flexure side of the load beam at least partially within the recess.

17. The magnetic storage system of claim 16, wherein the hinge biases towards a surface of at least one disk of the quantity of disks to allow a head of the distal end portion to read data from and/or write data to the at least one disk.

18. The magnetic storage system of claim 16, wherein:
the load beam comprises a first load beam;
the base plate comprises a first base plate;
the recess comprises a first recess;
the carriage further comprises a second load beam, a second base plate, and a second recess formed in the second load beam; and
the second recess faces away from the first recess.

19. A method of manufacturing a suspension assembly of a magnetic storage device, the method comprising:
attaching a flexure to a means for at least partially insetting the flexure into a load beam on a flexure side of the load beam, wherein the flexure side is opposite to a base-plate side of the load beam.

20. The method of claim 19, wherein the means for at least partially insetting the flexure into the load beam comprises a recess in the flexure side and the method further comprises forming the recess into the flexure side by removing material from the load beam to form the recess such that a ratio of a thickness, of a non-recessed portion of the load beam immediately adjacent to the recess, to a depth of the recess is between and inclusive of 1 and 2.3.
